(19) United States
(12) Patent Application Publication
(10) Pub. No.: US 2003/0182040 A1
(43) Pub. Date: Sep. 25, 2003

(54) Self triggering impact protection system

(76) Inventor: Maximilian E Davidson, Herzlia (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/363,466

(22) PCT Filed: Aug. 30, 2001
(86) PCT No.: PCT/IL01/00822

(30) Foreign Application Priority Data
Sep. 4, 2000 (IL) 138240

(51) Int. Cl. G05D 1/00

(52) U.S. Cl. 701/45; 180/271

(57) ABSTRACT

An impact minimization device for a user includes a processor that transmits a signal in response to an indication of upcoming impact, an inflatable member, and a gas source, flexibly disposed within the inflatable member, which, in response to the signal, inflates the inflatable member. The processor may be disposed within the inflatable member and may be in wireless communication with the gas source. Furthermore, the processor may include at least one sensor and a logic unit. The logic unit may compare sensed data from the sensor with pre-defined data, determine when the sensed data indicates upcoming impact, and activate the gas source thereupon.

### FIELD OF THE INVENTION

The present invention relates, in general, to systems that protect from impacts, and, in particular, to electronic self-triggering systems thereof.

### BACKGROUND OF THE INVENTION

There are various types of prior art protection systems designed to protect users from impact. Some of these systems are wearable garments or belts that contain inflatable members designed to inflate upon contact. Other systems comprise inflatable members located at a distance from the user and are designed to come between the user and the source of the impact, such as car airbags.

Typically, prior art protection systems comprise an activation device that triggers inflation of the inflatable member. The activation device may be either manually or automatically activated. When using manual activation devices there may be a time delay due to human reaction time, and, hence, the inflatable member may not inflate quickly enough to provide protection from impact. When using an automatic activation device, generally the protection system may comprise a sensor that senses the impact, and, in appropriate circumstances, activates triggering. If the sensor/activation device is not accurate effective enough, the triggering timing may be off, causing either false inflation or delayed inflation during real impacts.

There exists a need for an improved protection device that provides accurate trigger activation and effective protection of the user from impact.

### SUMMARY OF THE INVENTION

An object of the present invention is to provide a self-triggering protection system that includes electronic sensing and triggering of an inflatable member, which is optionally provided as a complete one-unit system.

There is therefore provided in an embodiment of the present invention an impact minimization device for a user. The device includes a processor, which transmits a signal in response to an indication of upcoming impact, an inflatable member, and a gas source, flexibly disposed within the inflatable member, which, in response to the signal, inflates the inflatable member.

The processor may be disposed within the inflatable member and may be in wireless communication with the gas source. Furthermore, the processor may include at least one sensor, and a logic unit. The logic unit may compare sensed data from the sensor with pre-defined data, determine when the sensed data indicates upcoming impact, and activate the gas source thereupon. The processor may also include an activation unit for activating the gas source.

The pre-defined data may define probable conditions generated by kinetic, dynamic, physiological and/or psychological events. The data may be measurements of acceleration, tilt, velocity, angular velocity, distance, pulse rate, brain wave, or perspiration. The at least one sensor may be an accelerometer, a speedometer, a tilt sensor, a pressure detector, a gyroscope a physiological monitor, a blood pressure sensor, or a perspiration detector. The sensor may be located on the body of the user, on or part of the vehicle, and/or one or more other bodies that may be part of the surrounding environment.

The predefined data and the sensed data may be stored in a memory. The memory may also store system parameters representative of the device. The data stored in the memory may be accessible after the inflation of the member.

There is therefore additionally provided in an embodiment of the present invention an impact minimization device for a user, which device includes an inflatable member, a processor and a gas source; both the processor and the gas source may be disposed within the inflatable member. The device may be employable within a wearable garment such as a jacket or a belt. Alternatively, the device may be employable within a seat of a moving medium, such as a motorcycle, a car, a train, a bus, a ski, an airplane or a water vessel.

There is therefore furthermore provided in an embodiment of the present invention an impact minimization device for a user, which device may include at least one master processor and at least one inflatable member. Each inflatable member may include a gas source flexibly disposed within its associated inflatable member, and a slave processor in communication with the at least one master processor. At least one of the master processors, upon receipt of an indication of upcoming impact, may selectively indicate to at least one of the slave processors to activate its associated gas source to inflate its associated inflatable member.

The slave processor may be disposed within the associated inflatable member and may include an associated identification protocol. Also, the master processor may include a master protocol that recognizes each associated identification protocol and enables selective communication thereto.

The at least one inflatable member may also be disposed within a wearable garment or at least part of a seat of a moving medium, such as a train, a bus, or a car.

The at least one master processor may be in wireless communication with the slave processor. Either the master processor or the slave processor may include at least one sensor that senses data indicative of upcoming impact. Additionally, the master processor may include logic that compares the sensed data to pre-defined data, to determine when sensed data indicates the upcoming impact, and to activate the gas source thereupon. Either the master processor or the slave processor may include memory for storing data indicative of upcoming impact.

There is therefore furthermore provided in an embodiment of the present invention a processor for use with an impact-minimization device. The processor may include at least one sensor; a logic unit, a memory, an activation unit, a transceiver and a power source. The power source may be connectable to a moving medium.

### BRIEF DESCRIPTION OF THE DRAWINGS

The present invention will be understood and appreciated more fully from the following detailed description taken in conjunction with the appended drawings, in which:

FIG. 1a is a schematic illustration of a protection system constructed and operative according to an embodiment of the present invention;

FIG. 1b is a schematic illustration of the electronics used in the system of FIG. 1a;

FIG. 2a is a schematic illustration of an alternative protection system constructed and operative according to an embodiment of the present invention;

FIG. 2b is a schematic illustration of the electronics used in the system of FIG. 2a; and

FIG. 3 is a schematic illustration of an alternative protection system constructed and operative according to an embodiment of the present invention.

### DETAILED DESCRIPTION OF THE PRESENT INVENTION

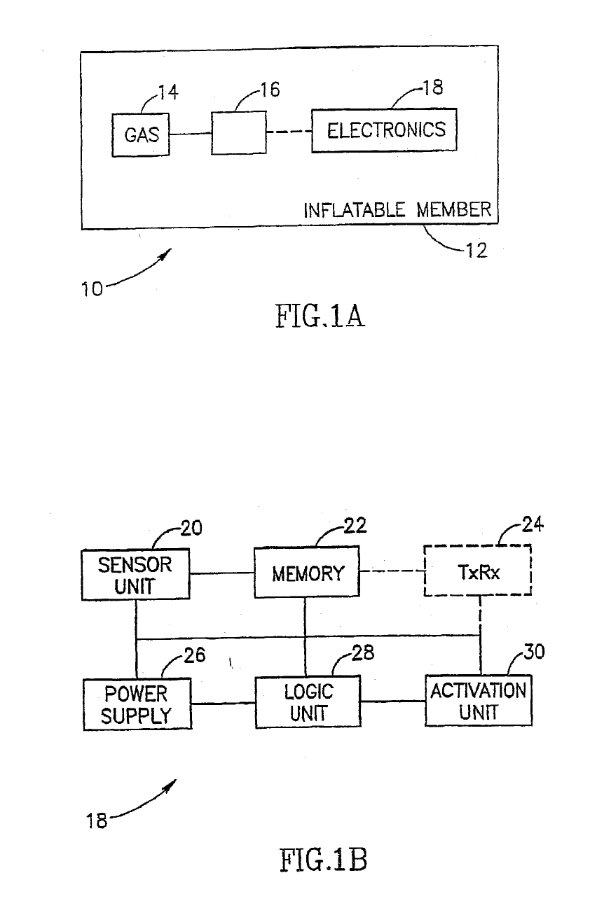

Reference is now made to FIG. 1A, an illustration of a protection system constructed and operative according to an embodiment of the present invention. System 10 may comprise an inflatable member 12, a gas source 14, a trigger 16, and an electronics system 18.

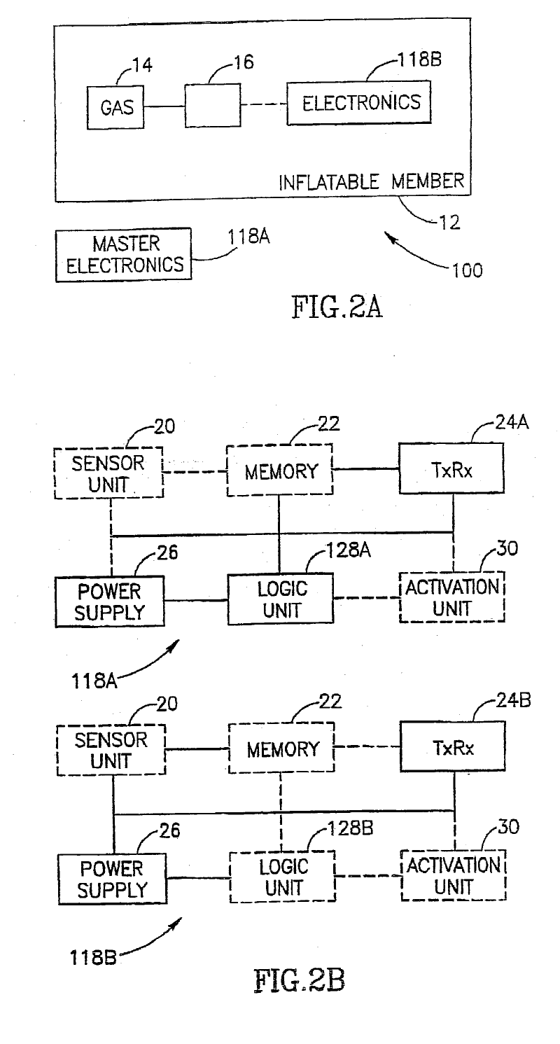

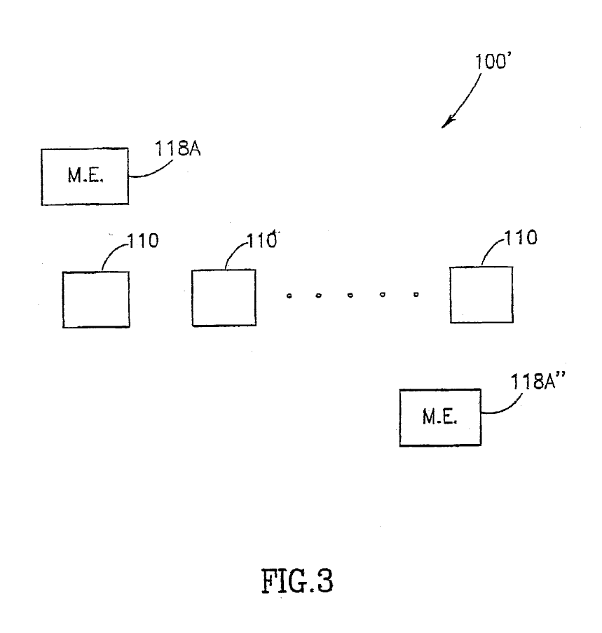

Electronics system 18 may sense parameters indicating a condition, such as an approaching impact, causing activation of trigger 16, which in turn causes gas source 14 to inflate inflatable member 12. Processor 18 is described in detail hereinbelow in connection with FIG. 1B. It is noted that protection system 10 may be a self-contained unit with all the elements (elements 12 to 18) in one platform, or it may be comprised of multiple platforms, as described in detail in FIGS. 2 and 3.

An example of a one-platform application may be a self-contained kit suitable for insertion into garments or belts. An example of such may be motorcycle-riding garments, ski jackets, or the like. System 10 may also be constructed as an upgrading kit comprising inflatable member 12, gas source 14, trigger 16, and processing unit 18 employable in seats of moving vehicles, such as back seats in a car, bus, train, or the like. Protection system 10, once fitted into the appropriate location, may sense an approaching fall or impact, cause inflatable member 12 to inflate and, hence, provide protection from the approaching impact.

Inflatable member 12 may be any applicable type of inflatable member such as an airbag, with one or more divisions. Gas source 14 may be any applicable source of gas, such as a cold gas generator or other source of pressurized gas, such as a Weltz Industry gas generator, or the like. Alternatively gas source 14 may be a plurality of pressurized gas canisters and may contain compressed air, helium, or the like. In some embodiments, gas source(s) 14 are flexibly employed within inflatable member 12. Alternatively, gas source 14 may be a gas canister built from one or more internal/external chambers, or a pressurized vessel containing more than one internal chamber, filled with gas, such as helium, compressed air, argon, etc. Gas source 14 may release the gas from each chamber separately or simultaneously by a mechanical, electrical, pyrotechnic, or electronic device. The release may be one or more than one device acting separately or together.

Processing unit 18 may be a self-contained wireless system and/or wired system designed to sense physical parameters such as velocity, acceleration, distance, angular displacement, acceleration, height, proximity, etc., and, in appropriate circumstances, to cause trigger 16 to activate. Processor 18 may also have the ability to store in memory (FIG. 1B) the parameters of system 10 prior to, during and after the triggering of trigger 16, and, as such, act as a “black box” for accident-investigation purposes.

Reference is now made to FIG. 1B, a block diagram of elements comprised within processor 18. Processor 18 may comprise a sensor unit 20, a memory 22, a transceiver 24, a power supply 26, a main logic unit 28, and an activation unit 30. The elements of processor 18 may be off-the-shelf items and may not require special specific knowledge to be modified or implemented.

It is apparent to those skilled in the art that processor 18 may be a software application that performs the function noted herein, or may be an electronics unit that performs said functions.

The elements of processor 18 may be located in one central area, such as a board, to facilitate compactness within system 10. Alternatively, one or more elements of processor 18 may be located at a distance from processor 18, as required for the specific platform. As an example, either sensor unit 20 or power supply 26 may be external to processor 18.

Sensor unit 20 may comprise one or more sensors, such as accelerometers, speedometers, tilt sensors, gyroscopes etc., as required for the appropriate applications of system 10. Sensor unit 20 may be a physiological sensor such as a blood-pressure monitor or heart monitor. Sensor unit 20 may provide generally continuous monitoring of parameters such as acceleration, tilting, angular velocity, distance, etc. The parameters may be representations of probable conditions generated by kinetics, dynamics, physiological and/or psychological events.

As an example, for motorcycle applications, sensor unit 20 may sense G force and/or acceleration/deceleration over time. Alternatively, for amateur bicycle applications, sensor unit 20 may comprise tilt sensors that monitor the level of the rider. In other embodiments, sensor unit 20 may comprise a gyroscope for more complex movements (6 or more movement axes).

Additionally, sensor unit 20 may receive inputs from various external sources and/or sensors (not shown), which may be attached to an applicable vehicle, animal, or other moving item. As an example, more than one sensor unit 20 may be interconnected to cover a larger “sensing” area, forming a net of sensor units 20. Alternatively, sensor unit 20 may be located at a distance from processor 18 and provide signals via a direct connection and/or a wireless system. As an example, for motorcycle applications, sensor unit 20 may be employable within inflatable member 12 and sense local conditions, or, alternatively, sensor unit 20 may be located on the applicable motorcycle and send signals to processor 18, which may be located within inflatable member 12.

Alternatively, for skiing applications, sensor unit 20 may comprise a pressure device attachable to a binding of a ski and located under a ski boot of the user. When the pressure device on the binding registers lack of pressure, a signal is released indicating to processor 18 that the boot has released from the binding.

In some embodiments, the levels monitored by sensor unit 20 may be fed into logic unit 28, where they are compared to pre-defined threshold values, and/or new learned values acquired during the use of the system10. System 10 learns new values by generally constantly replacing old values with values recently sensed by one or more sensor unit 20. The system may use pre-defined data and/or data just received.

Memory 22 may be used for storing the system status and the measured values of pre-defined parameters (not shown). The pre-defined parameters may be defined per application, and may include parameters such as G-force, acceleration, tilt, velocity, angular velocity pressure, distance, pulse rate, brain wave, perspiration, and the like. The pre-defined parameters may be red-line indications of an approaching impact or accident. As an example, for motorcycle applications, the pre-defined parameters may be 30G in 10 msec. Once those parameters are surpassed, it may be an indication of an impending accident (whereas, in contrast, disturbance due to a normal pot-hole may be 10G in 35 msec). Alternatively, for amateur bicycle applications, the predefined parameter may be 60-degree tilt. It is noted that the above measurements are for exemplary purposes only, and may vary from application to application.

Memory 22 may provide to logic unit 28 the pre-defined parameters. Logic unit 28 may compare the values received from sensor units 20 with the data received from memory 22, and, when the predefined levels as received from memory 22 are surpassed by the information received from sensor unit 20, logic unit 28 may cause inflation of protection system 10. As an example, for motorcycle applications, when the pre-defined parameter of 30G in 10 msec is surpassed by the data received from sensor unit 20, it may be an indication of an impending accident and logic unit 28 may cause inflation of inflatable member 12.

It is appreciated by those skilled in the art that system 10 is adaptable for various applications for which pre-defined and/or new parameters of detection may be defined. Examples of such are motorcycle racing, downhill racing, etc.

Furthermore, memory 22 may also store past and/or current data as sensed by sensor unit 20, and thus, in the instance of an accident, provide information which may be downloaded, as with a “Black Box” system used in aircraft. Downloading may be done by wire and/or wireless communication. Additionally, memory 20 may be re-settable.

Activation unit 30 may receive instructions from logic unit 28, causing activation of trigger 16. Communication from logic unit 28 to activation unit 30 may be by a local, wired and/or wireless signal. As an example, in the motorcycle application, when logic unit 28 receives parameters indicating an impending accident, it may activate activation unit 30, which in turn triggers trigger 16, causing inflation of protection system 10.

Power supply 26 may be manual and/or automatic, and may comprise an ON/OFF switch. Furthermore, power supply 26 may be self-powered, such as with batteries, and/or powered by an external source, such as a car battery. As such, power supply 26 may be attached to an appropriate vehicle, animal, or any other moving system of the chosen application. As an example, when system 10 is provided as a kit, electronics 26 may comprise batteries. However, when system 10 is used in a vehicle of any type with or without a propulsion unit but not limited to such an application, power supply 26 may be attached to the vehicle battery, or may use its own battery, without an intermediate element. An example of such may be a motorcycle application, wherein the motorcycle battery may power system 10.

Transceiver 24, optional, may receive signals from an external sensor 20. As an example, for motorcycle applications or skiing applications, if sensor unit 20 is located on the motorcycle or ski, respectively, transceiver 24, may receive the signal from sensor unit 20, and transfer the signal to logic unit 28. Transceiver unit 24 may additionally transmit a wireless pulse which may trigger activation unit 30, if located at a distance from system 10. More than one sensor unit 20 may be used, in either series or parallel connection.

Logic unit 28 may comprise a digital display, and it may communicate with system 10 via wired and/or wireless connections. Logic unit 28 may also perform regular status tests of system 10 and provide the user with a continuous status display of pre-defined system parameters. Alternatively, system 10 may alert the user to system failures, such as low battery or malfunctioning sensor unit 20.

It will be appreciated that the properties and qualities of system 10 may be adapted for use with other protective systems, such as horse-back riding, water skiing, or other moving systems of any nature

Reference is now made to FIGS. 2A and 2B, an alternative protection system 100, which, although similar to system 10, is constructed on two platforms. Elements similar to those of FIGS. 1A and 2A are similarly numbered and will not be described further.

System 100 comprises two sections, protection member 110 and master processor 118A. Protection member 110 may comprise slave processor 118B. Typically, protection member 110 is worn by the user, in the form of either a belt or garment, or may simply be situated close to the user, such as on a baby car carrier. Master processor 118A may be located on either a vehicle or other device distant from the user, and may be in contact with protection member 110 via slave processor 118B.

In an example application, system 100 may be used as a motorcycle protective system. Member 110, being self-contained, may fit into any type of motorcycle riding garment, and master processor 118A may be attached to a motorcycle or other type of moving vehicle or animal used for locomotion and/or racing, such as cars, tractors, trains, or aircraft and the like.

Master processor 118A may comprise transceiver 24A, power supply 26, and logic unit 128A. Slave processor 118B may comprise transceiver 24B, power supply 26, and logic unit 128B.

Sensor unit 20, memory 22, and activation unit 30 may optionally be comprises on either processor 118A or 118B, as applicable. As an example, if member 110 is a garment, sensor unit 20 may be located with member 110 on the user's body, and may consequently sense when the user is dislodged from his position. Alternative, sensor 20 may be comprised within/on a motorcycle body and sense the parameters of the motorcycle.

Slave processor 118B may be smart, whereas logic unit 128B may be able to perform functions such as comparison between memory 22 and sensor unit 20. Alternatively, slave processor 118B may be stupid, and react to signals received from master processor 118A, As such, if slave processor 118B is stupid, sensor unit 10 and memory 22 may be comprised in master processor 118A.

In some embodiments, logic unit 128A may activate activation unit 30, which may be comprised in either master processor 118A or slave processor 118B.

System 100 may comprise a communication protocol for enabling communication between master processor 118A and one or more users (e.g. one or more slave processor 118B). To this end, logic unit 128B may comprise the identify logic for a specific user. Correspondingly, logic unit 128A may comprise protocol enabling the differentiation between one or more users (e.g. one or more logic units 128B). Thus, master processor 118A, via logic unit 128A, is able to identify each user's ID and hence avoid communication with any unidentified users.

Additionally, since master processor 118A may differentiate between users, logic unit 128A may selectively activate logic units 128B, causing selective inflation of protection members 110. In such an instance, logic unit 128A may activate one protection member 110 while leaving another non-activated.

In some embodiments system 100 may be provided as a complete set, and the identification codes and communication protocols may be pre-defined. As an example, both member 110 and processor 118A may be supplied as a unit, and thus, the protocol in logic unit 128A and the ID in logic unit 128B may be predefined. Alternatively, however, in other embodiments system 100 may be supplied as a two-part system; e.g. master processor 118A may be supplied separately from member 110. As an example, master processor 418A may be a built-in part of a motorcycle, and member 110 may be supplied separately as part of a jacket. In this instance, logic units 128A and 128B may be provided with a mating protocol enabling the ID of logic unit 128B to be burned into the protocol of logic unit 128A, or vice versa.

Communication between master processor 118A and slave processor 118B may be provided via wireless communication between transceivers 24A and 24B. Alternatively, transceivers 24A and 24B may be used for all the functions noted above in connection with system 100.

System 100 or parts of thereof may be installed in more than one location and/or divided between more than one location.

Reference is now made to FIG. 3, an illustration of protection system 100′, an alternative embodiment of protection system 100. System 100′ may comprise multiple members 110 and multiple master processors 118A, as applicable.

An examples of such use may be a public train platform. The engine car and caboose may each comprise master processor 118A, whereas each seat may comprise a member 110. Each member 110 comprises its own ID code, and hence, may be activated by either one of the master processors 118A, from either the engine car or the caboose, as applicable. In an alternative embodiment, as may be used in a passenger train with seats facing each other, the inflatable member 110 may drop from above and provide cushioning for one or more passengers by facing the member 110 to all of them. Alternatively, for passengers sitting one behind the other, the inflatable member 110 may be part of the seat in front of the user, and/or may be an ‘upgrade kit’ mounted on the back of existing seats in trains. of the seat in front of the user, and/or may be an ‘upgrade kit’ mounted on the back of existing seats in trains.

Although the example herein refers to trains, it is understood that alternative platforms and/or any other types of vehicles such as cars, bus seats, pleasure boats, etc. are applicable. Similarly, the shape of the inflatable member can vary, such as a cylindrical shape for use in train seats facing each other or specially shaped members to accommodate small children or pregnant women.

Master processor 118A may ‘talk’ to one or more slave processors 118B, and/or one slave processors 118B may ‘talk’ with one and/or more other slave processors 118B after it receives a ‘command’ from its master processor 118A. There may also be a situation in which one or more master processors 118A ‘talk’ with one other or more slaves. The communication, or ‘talk’, may be via a wired or a wireless connection.

Alternatively, for a motorcycle application, one master processor 118A may be located on the motorcycle, and each passenger, whether rider or driver, may be assigned a member 110.

It will be appreciated by persons skilled in the art that the present invention is not limited by what has been particularly shown and described herein above. Rather the scope of the invention is defined by the claims that follow:

What is claimed is:

1. An impact minimization device for a user, the device comprising:
a processor which transmits a signal in response to an indication of upcoming impact;
an inflatable member; and
a gas source disposed within said inflatable member, which in response to said signal, inflates said inflatable member.

2. A device according to claim 1, wherein said processor is disposed within said inflatable member.

3. A device according to claim 1, wherein said processor is in wireless communication with said gas source.

4. A device according to claim 1 , wherein said processor comprises:
at least one sensor; and
a logic unit which compares sensed data from at least one said sensor to pre-defined data defining probable impact conditions, to determine when sensed data indicates said upcoming impact, and to activate said gas source thereupon.

5. A device according to claim 4, wherein said pre-defined data is at least one of a group consisting of the following: acceleration, tilt, velocity, angular velocity, distance, pulse rate, brain wave, and perspiration.

6. A device according to claim 4, wherein said at least one sensor is at least one of a group consisting of the following: an accelerometer, a speedometer, a tilt sensor, a pressure detector, a gyroscope, a physiological monitor, a blood pressure sensor, and a perspiration detector.

7. A device according to claim 4, wherein said at least one sensor is located at one of the following locations: on a moving medium, next to said user's skin, on said user's body, and part of a moving medium.

8. A device according to claim 4, wherein said processor comprises a memory which stores said pre-defined data

9. A device according to claim 8, wherein said processor comprises a memory which stores said sensed-defined data

10. A device according to claim 8, wherein said memory stores system parameters representative of said device.

11. A device according to claim 10, wherein said data stored in said memory are accessible after said inflation of said member.

12. A device according to claim 4, wherein said processor comprises an activation unit for activating said gas source.

13. A device according to claim 4, wherein said processor comprises a power source.

14. A device according to claim 13, wherein said power source is connectable to a power source of moving medium.

15. An impact minimization device for a user, the device comprising:
an inflatable member;
a processor disposed within said inflatable member, wherein said processor transmits a signal in response to an indication of upcoming impact; and
a gas source flexibly disposed within said inflatable member, which in response to said signal, inflates said inflatable member.

16. A device according to claim 15, wherein said device is employable within a wearable garment.

17. A device according to claim 16, wherein said wearable garment is a jacket, a belt, a vest, a belt and a harness.

18. A device according to claim 15, wherein said device is employable within a seat of a moving medium.

19. A device according to claim 18, wherein said moving medium is at least one of a group comprising the following: a motorcycle, a car, a train, a bus, and a ski.

20. An impact minimization device for a user, the device comprising:
at least one master processor; and
at least one inflatable member, each said inflatable member comprising:
a gas source flexibly disposed within it's associated inflatable member; and
a slave processor in communication with said at least one said master processor;
wherein said at least one master processor, upon receipt of an indication of upcoming impact, selectively indicates to at least one said slave processor to activate its associated said gas source to inflate its said associated inflatable member.

21. A device according to claim 20, wherein said slave processor is disposed within said associated inflatable member.

22. A device according to claim 20, wherein said slave processor comprises an associated identification protocol.

23. A device according to claim 22, wherein said master processor comprises a master protocol which recognizes each said associated identification protocol and enables selective communication thereto.

24. A device according to claim 20, wherein said at least one inflatable member is employable within a wearable garment.

25. A device according to claim 20, wherein said at least one inflatable member is disposable within at least part of a seat of a moving medium.

26. A device according to claim 25, wherein said moving medium is at least one of a group consisting of the following: a train, a bus, a car, an airplane and a water vessel.

27. A device according to claim 20, wherein said at least one master processor is in wireless communication with said slave processors.

28. A device according to claim 20, wherein at least one of said master processor and said slave processor comprises at least one sensor which senses data indicative of said upcoming impact.

29. A device according to claim 28, wherein at least one of said master processors comprises logic which compares sensed data from at least one of said sensors to pre-defined data defining probable impact conditions, to determine when sensed data indicates said upcoming impact, and to activate said gas source thereupon.

30. A device according to claim 20, wherein at least one of said master processor and said slave processor comprises memory for storing data indicative of said upcoming impact.

31. A processor for use with impact minimization device, the processor comprising:
at least one sensor; and
a logic unit which compares sensed data from said at least one sensor to pre-defined data defining probable impact conditions, to determine when sensed data indicates said upcoming impact, and to activate said gas source thereupon.

32. A device according to claim 31, wherein said processor comprises a memory for storing said data.

33. A device according to claim 32, wherein said memory stores system parameters representative of said device.

34. A device according to claim 33, wherein said data stored in memory are accessible after said inflation of said member.

35. A device according to claim 31, wherein said processor comprises an activation unit for activating said gas source.

36. A device according to claim 31, wherein said processor comprises a transceiver.

37. A device according to claim 31, wherein said processor comprises a power source.
